(19) United States
(12) Patent Application Publication
(10) Pub. No.: US 2022/0300229 A1
(43) Pub. Date: Sep. 22, 2022

(54) PRINT APPARATUS

(71) Applicant: SEIKO EPSON CORPORATION, Tokyo (JP)

(72) Inventor: Kikuo UENO, Matsumoto (JP)

(21) Appl. No.: 17/655,560

(22) Filed: Mar. 21, 2022

(30) Foreign Application Priority Data
Mar. 22, 2021 (JP) 2021-046973

(51) Int. Cl. G06F 3/12

(52) U.S. Cl. CPC G06F 3/1261; G06F 3/1204; G06F 3/1274; G06F 3/1255

(57) ABSTRACT

The print apparatus includes an obtaining section that obtains information on a print job of another print apparatus and a display controller that displays, among print jobs included in the other print apparatus, a first job that is printable by itself and a second job that is not printable by itself as a list in a distinguishable manner.

The present application is based on, and claims priority from JP Application Serial Number 2021-046973, filed Mar. 22, 2021, the disclosure of which is hereby incorporated by reference herein in its entirety.

### BACKGROUND

### 1. Technical Field

The present disclosure relates to a print apparatus.

### 2. Related Art

In general, a print system sharing a print job by a plurality of print apparatuses capable of communicating with one another through a network has been used. In this case, a print apparatus which is different from a print apparatus which has received a print job may execute a print process for the print job. JP-A-2020-082468 discloses a method for enabling execution of a print process and obtainment of a result of the printing in an arbitrary print apparatus irrespective of a print apparatus receiving a print job.

However, when a print job is shared in a print system including a plurality of print apparatuses, a print job stored in a given one of the print apparatuses may not be processed by the other print apparatuses due to restriction of capability of the print apparatuses. Even in this case, at least a little improvement of usability is demanded.

### SUMMARY

According to an aspect of the present disclosure, a print apparatus connectable to another print apparatus through a network includes an obtaining section that obtains information on a print job of the other print apparatus, and a display controller that displays, among print jobs of the other print apparatus, a first job that is printable by itself and a second job that is not printable by itself as a list in a distinguishable manner. The display controller performs display control for enabling a print designation to be performed by a user on the first job, performs display control for disabling the print designation to be performed by the user on the second job, and performs display control of a guide designation for guiding the second job to the other print apparatus configured to print the second job.

According to another aspect of the present disclosure, a print apparatus connectable to another print apparatus through a network includes an obtaining section configured to obtain information on a print job of the other print apparatus, and a display controller configured to display in a first screen, among print jobs of the other print apparatus, a first job that is printable by itself and a second job that is not printable by itself as a list such that only one of the first and second jobs is selectable. The display controller performs display control for displaying a deletion screen for enabling a designation of deletion of a print job included in the other print apparatus separately from the first screen, and performs display control such that the first job and the second job are distinguishable and selectable in the deletion screen.

### BRIEF DESCRIPTION OF THE DRAWINGS

FIG. 1 is a diagram illustrating an example of a configuration of a print system including print apparatuses.

FIG. 2 is a diagram illustrating a configuration of the print apparatuses.

FIG. 3 is a flowchart of a process performed by the print system.

FIG. 4 is a diagram schematically illustrating a process of storing a print job.

FIG. 5 is a sequence diagram illustrating the process of storing a print job.

FIG. 6 is a diagram schematically illustrating a process of obtaining information on a print job.

FIG. 7 is a sequence diagram illustrating the process of obtaining information on a print job.

FIG. 8 is a sequence diagram illustrating a print process.

FIG. 9 is a flowchart of a process of screen display.

FIG. 10 is a diagram illustrating an example of a screen employing a method according to this embodiment.

FIG. 11 is a diagram illustrating another example of a screen employing the method according to this embodiment.

FIG. 12 is a diagram illustrating an example of a screen according to a modification of this embodiment.

### DESCRIPTION OF EXEMPLARY EMBODIMENTS

Hereinafter, an embodiment will be described. Note that the embodiment below does not unreasonably limit content of the present disclosure disclosed in claims. It is not necessarily the case that all components described in this embodiment are requirements of the present disclosure.

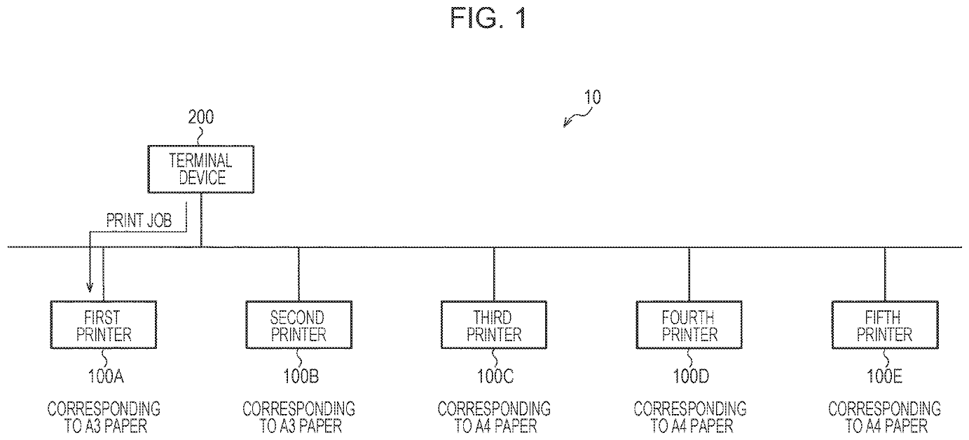

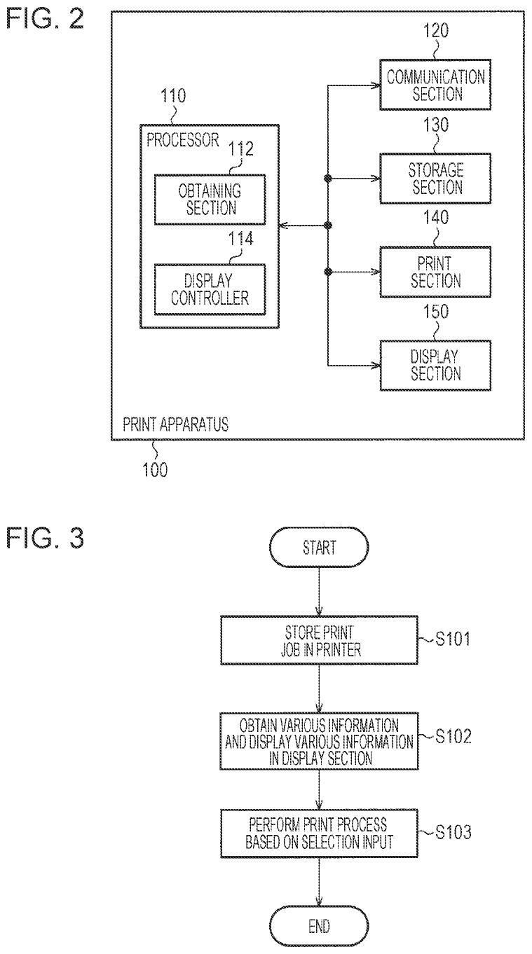

Examples of a configuration of print apparatuses 100 and a configuration of a print system 10 including the print apparatuses 100 will be described with reference to FIGS. 1 and 2. FIG. 1 is a diagram illustrating an example of a configuration of the print system 10 in which a print job is shared by the plurality of print apparatuses 100. Although the print apparatuses 100 correspond to five printers, that is, first to fifth printers 100A to 100E, in FIG. 1, the number of print apparatuses 100 is not limited to five.

The first to fifth printers 100A to 100E are capable of communicating with one another through a network. The network may be an internal network, such as an intranet, or a network using a public line, such as the Internet.

A terminal device 200 transmits a print job to a given print apparatus 100 through the network. The terminal device 200 is a personal computer (PC), for example, and may be a mobile terminal device, such as a smartphone or a tablet terminal. The number of terminal devices 200 is not limited to one, and a plurality of terminal devices 200 may be connected to the network.

It is assumed here that, in this embodiment, the first and second printers 100A and 100B support printing on A3 paper. On the other hand, it is assumed that the third to fifth printers 100C to 100E support printing on A4 paper and may not process a print job set as printing on A3 paper.

FIG. 2 is a diagram illustrating an example of a configuration of the print apparatuses 100. Each of the print apparatuses 100 includes a processing section 110, a communication section 120, a storage section 130, a print section 140, and a display section 150. The processing section 110 includes an obtaining section 112 and a display controller 114. Note that the configuration of the print apparatus 100 is not limited to that illustrated in FIG. 2, and various modifications may be made by omitting a number of the components or adding other components, for example. Each of the print apparatuses 100 may be a multifunction peripheral (MFP) having a plurality of functions including a print function.

The processing section 110 controls the various sections included in the print apparatus 100, such as the communication section 120. The processing section 110 is specifically a processor or a controller. The processing section 110 may include a plurality of CPUs including a main CPU and a sub CPU, for example. The main CPU controls the sections included in the print apparatus 100 and the entire print apparatus 100. The sub CPU controls communication performed by the communication section 120, for example. Note that the processing section 110 may further include a CPU that performs various processes associated with printing.

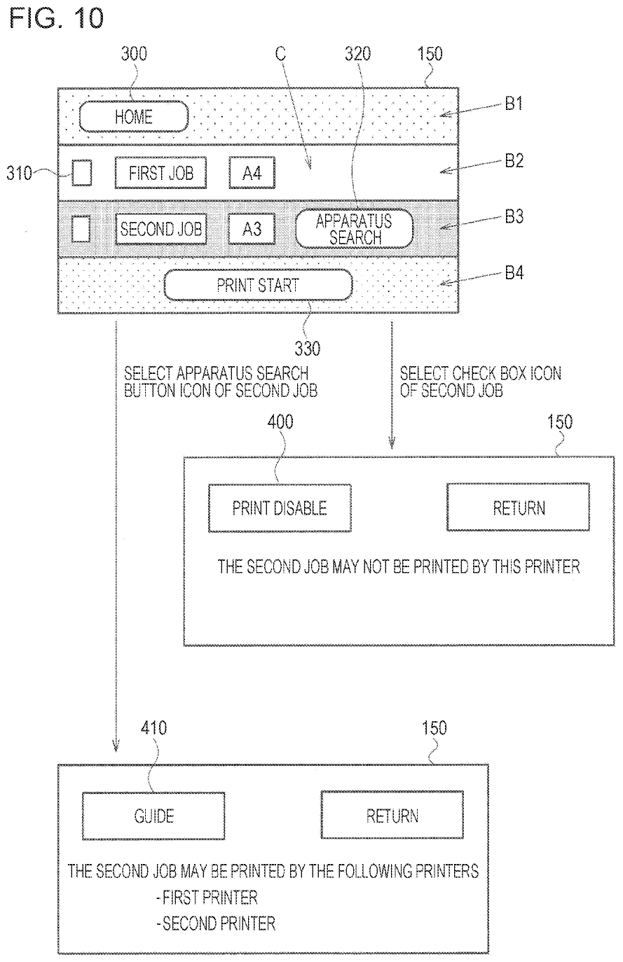

The processing section 110 of this embodiment may be configured by hardware described below. The hardware may include at least one of a circuit that processes digital signals and a circuit that processes analog signals. For example, the hardware is configured by at least one circuit device or at least one circuit element implemented on a circuit substrate. Note that examples of the circuit device include an integrated circuit device. Furthermore, examples of the circuit element include an active element, such as a transistor, and a passive element, such as a resistor or a capacitor. Furthermore, the processing section 110 may be realized by a processor below. The print apparatus 100 of this embodiment includes a storage section 130 described below storing information and a processor operating based on the information stored in the storage section 130. The processor includes hardware. Furthermore, as the processor, various types of processor may be used, such as a central processing unit (CPU), a graphics processing unit (GPU), and a digital signal processor (DSP). Moreover, the storage section 130 herein may be a semiconductor memory, such as a static random access memory (SRAM) or a dynamic random access memory (DRAM), a register, a magnetic storage device, such as a hard disk device, or an optical storage device, such as an optical disc device. In addition, the storage section 130 stores computer-readable instructions, for example, and functions of the processing section 110 are realized as processes when the processor executes the instructions. The instructions may be an instruction set constituting a program or may indicate an operation to a hardware circuit of the processor, or a portion of or the entire processing section 110 may be realized by cloud computing. The obtaining section 112 obtains information on print jobs from the other print apparatuses 100 through the communication section 120 described below. The display controller 114 performs display control using the display section 150 described below in the print apparatus 100. The display controller 114 may be realized by a processor dedicated for display, for example, or the processor of the processing section 110 described above. The display controller 114 displays, among print jobs of the other print apparatuses 100, a first job that may be printed by itself and a second job that may not be printed by itself as a list in a distinguishable manner. Examples of the display will be described with reference to FIGS. 10 to 12 in detail.

The communication section 120 communicates with the other print apparatuses 100 and the terminal device 200 through the network. Here, the network may be realized by a wide area network (WAN) or a local area network (LAN) in a wired manner or a wireless manner. The communication section 120 is specifically an integrated circuit (IC) chip or a module that performs wired communication or wireless communication.

The storage section 130 stores various information including data and programs. The processing section 110 and the communication section 120 operate using the storage section 130 as a work area, for example. The storage section 130 may be a semiconductor memory, a register, a magnetic storage device, or an optical storage device as described above.

The print section 140 includes a print engine. The print engine has a mechanical configuration for executing printing of an image on a print medium. The print engine includes a transport mechanism, an ejection head employing an ink jet method, and a driving mechanism for a carriage that drives the ejection head. The print engine prints an image on a print medium by causing the ejection head to eject ink to the print medium transported from the transport mechanism. As the print medium, various media may be used, such as paper or fabric. Note that a concrete configuration of the print engine is not limited to that illustrated, and the print engine may perform printing using toner in an electrophotographic method.

The display section 150 is constituted by a display or the like that displays various information for the user. The display section 150 is a touch panel, for example, and also serves as an operation interface that accepts an input operation performed by the user.

The terminal device 200 transmits a print job to the first printer 100A, for example. A user who has transmitted the print job using the terminal device 200 moves to a desired one of the print apparatuses 100 so as to obtain a printing result in the print apparatus 100. Since the print job is shared, the print apparatus 100 from which the user obtains the printing result is not limited to the first printer 100A. The user may obtain the printing result using an arbitrary one of the first to fifth printers 100A to 100E.

It is assumed here that the user issues a print instruction to the second printer 100B. Examples of the print instruction include a login operation and an authentication operation described below. Each of the print apparatuses 100 of this embodiment shares a print job with the other print apparatuses 100 as illustrated in FIG. 1.

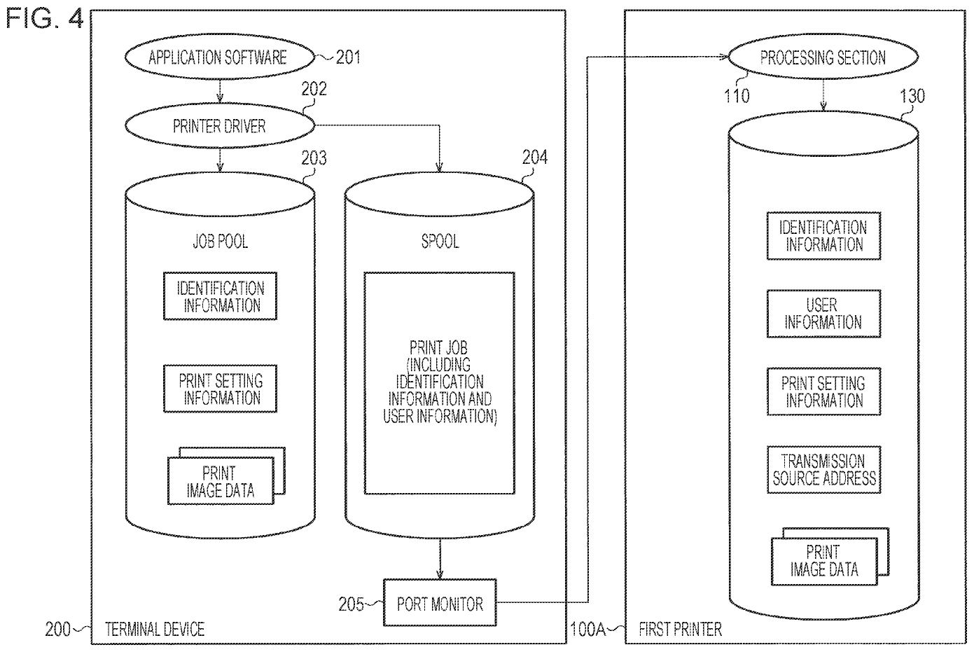

The print job herein represents aggregate of data to be used when one of the print apparatuses 100 executes one print process. The print job includes at least identification information for uniquely identifying the print job and print image data to be printed. Note that, as described below with reference to FIG. 4, a printer driver 202 of the terminal device 200 may perform a process of converting original data into print data of another format described in a page description language (PDL) or the like. In this case, the terminal device 200 stores the original data before the conversion. After receiving and analyzing the print data after conversion, the print apparatus 100 stores a result of the analyzing process. That is, a data format of the print job may vary depending on a situation. Although the print job in this embodiment and modifications thereof includes the original data and the print data, the print job may include information in another data format, such as the result of the analyzing process described above.

In FIG. 1, when the first to fifth printers 100A to 100E are the same model, a hardware configuration of the print apparatuses 100, characteristics of ink and toner to be used, and available print settings, and the like are in common. Specifically, a print job stored in a given one of the print apparatuses 100 may also be used in the other print apparatuses 100, and therefore, the print job may be easily shared.

However, when different models are mixed and a print job stored in a given one of the print apparatuses 100 is subjected to print processes performed by the other print apparatuses 100, a desired result may not be obtained. Specifically, a desired printing result may not be obtained when share of a print job is unqualifiedly permitted. For example, as described above, the first printer 100A and the third printer 100C support different paper sizes, that is, the third printer 100C that supports only A4 paper may not execute a print job corresponding to A3 paper.

FIG. 3 is a flowchart of a process performed by the print system 10 including the print apparatuses 100 according to this embodiment. When this process is started, first, the terminal device 200 executes a print process and a print job is stored in the storage section 130 of a given one of the print apparatuses 100 (step S101). Hereinafter, an example in which the print apparatus 100 that stores the print job corresponds to the first printer 100A will be described.

Subsequently, printing is instructed to one of the print apparatuses 100 to execute printing desired by the user. Hereinafter, an example in which the print apparatus 100 that is a main body of execution of the print process corresponds to the second printer 100B will be described. Specifically, the user performs an authentication operation using the second printer 100B. The authentication operation may be an operation of holding a given authentication card over a card reader, an operation of inputting authentication information, such as a user ID and a password, on a touch panel of the second printer 100B, or face authentication for a certain imaging apparatus. The authentication operation may be rephrased as a login operation. After performing the authentication process, the second printer 100B proceeds to a detailed process associated with printing when determining that the user is an authenticated user. Since the authentication printing is widely used, detailed description thereof is omitted.

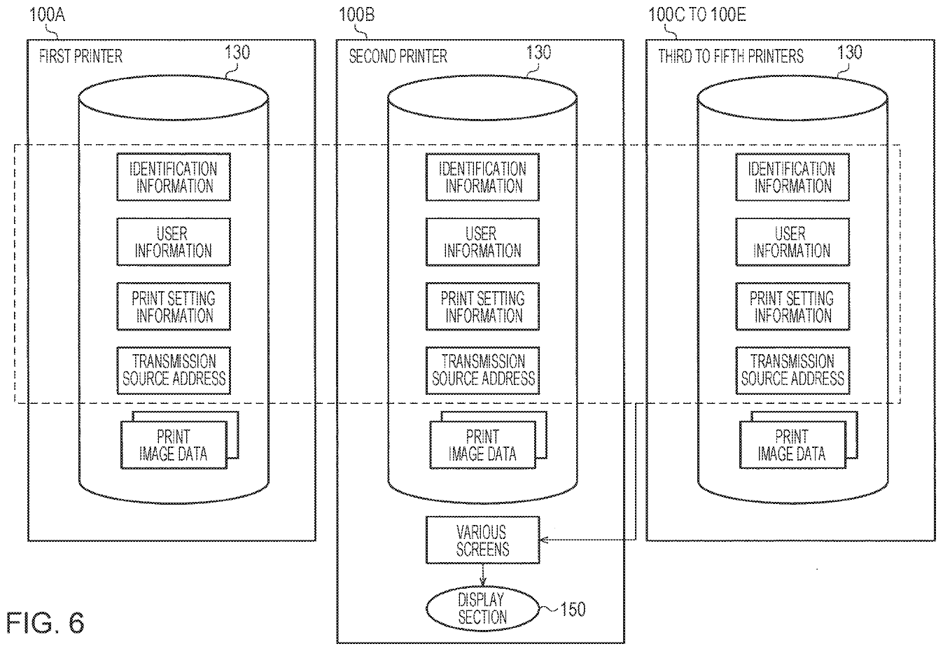

The second printer 100B obtains various information from the storage section 130 of itself and the other print apparatuses 100 through the network and displays a screen based on the obtained information in the display section 150 (step S102). Note that the examples of the screen herein include a home screen display 300 described hereinafter with reference to FIG. 10, and the second printer 100B obtains information on a print job required for the screen display. Note that, as described below with reference to FIG. 6, in the process in step S102, print image data that is a requirement of the printing is not required to be obtained.

After determining an execution target job by accepting a selection input of the execution target job performed by the user, the second printer 100B executes a print process on the execution target job (step S103). For example, the second printer 100B obtains the execution target job from the first printer 100A and executes printing on the obtained execution target job.

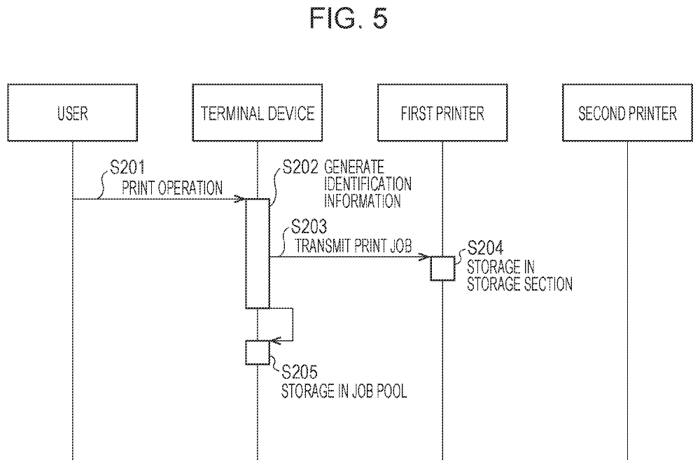

The process of storing a print job performed in step S101 of FIG. 3 will be described in detail with reference to FIGS. 4 and 5. FIG. 4 is a diagram schematically illustrating the process of storing a print job, and FIG. 5 is a sequence diagram of a flow of the process of storing a print job.

The user performs a print operation using application software 201 of the terminal device 200 (step S201). The application software 201 is arbitrary software that may be operated on an operating system (OS) of the terminal device 200 and may execute the print operation. Specifically, the terminal device 200 includes a processor and a memory that are not illustrated. The application software 201 is stored in the memory. When the processor operates in accordance with the application software 201, various functions of the application software 201 including the print operation are realized.

The printer driver 202 of the terminal device 200 generates print data to be stored in a spool 204 based on the print operation (step S202). The print data herein includes identification information of the print job and user information indicating the user who has generated the print job. The print data may be converted into data including print setting information and print image data after being subjected to an analyzing process performed by the first printer 100A.

The print data stored in the spool 204 is transmitted to the first printer 100A through an interface, such as a port monitor 205 (step S203). The spool 204 is a memory of the terminal device 200. The port monitor 205 is included in the terminal device 200 and is a communication interface for the print apparatuses 100. The printer driver 202 is software that is operable on the OS of the terminal device 200. The printer driver 202 is stored in the memory of the terminal device 200, and the processor of the terminal device 200 operates in accordance with the printer driver 202 so that various functions of the printer driver 202 including a process of generating print data are realized.

The first printer 100A receives the print data from the terminal device 200 and causes the processing section 110 to perform a process of analyzing a print language before storing a result of the analyzing process in the storage section 130 (step S204).

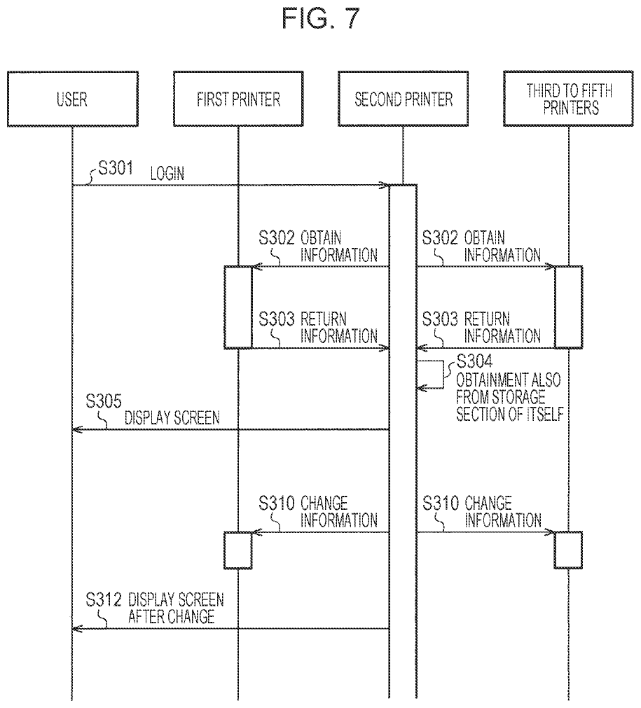

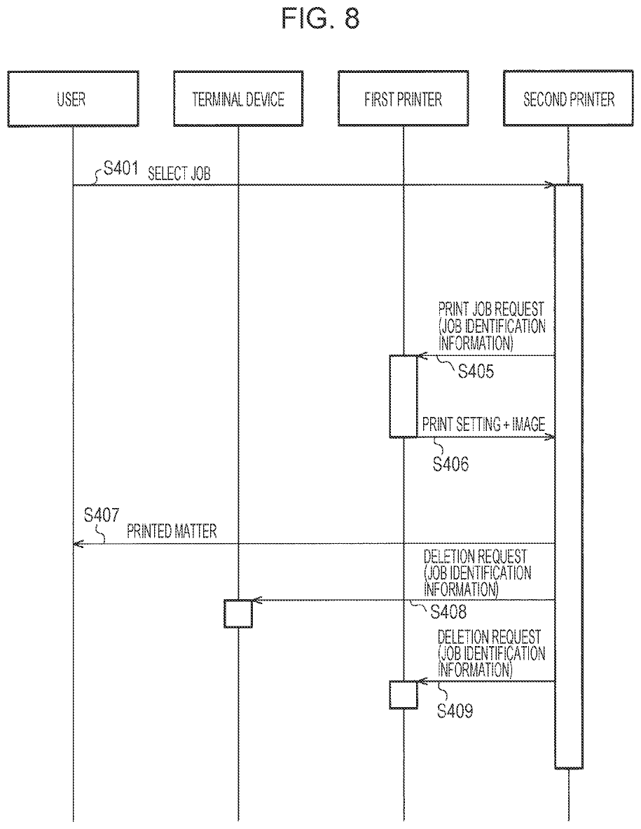

Furthermore, the terminal device 200 stores print image data for each page and identification information of the print job in a job pool 203 of itself (step S205). The job pool 203 is a memory of the terminal device 200. The job pool 203 and the spool 204 may be the same memory or different memories. Note that the second printer 100B does not operate at this time point and will be described with reference to FIGS. 7 and 8.

In FIG. 4, information stored in the job pool 203 of the terminal device 200 and information stored in the storage section 130 of the first printer 100A correspond to the print job. The print job includes, as illustrated in FIG. 4, identification information, print setting information, and print image data of the print job. Since the print job includes the identification information, the terminal device 200 and the print apparatuses 100 may execute appropriate processes without mixing up print jobs. Furthermore, the print image data is information for identifying an image to be printed. The print setting information is information on a size of print paper, and additionally includes information on a color/monochrome setting, a single-sided/double-sided print setting, and the number of copies. Since the print job includes the print setting information and the print image data, a desired image may be printed using a desired setting.

Furthermore, the print job stored in the first printer 100A that is one of the other print apparatuses 100 includes information for specifying the terminal device 200 that is a transmission source of the print job. The information for specifying the terminal device 200 is a transmission-source address indicating an address of the terminal device 200 which is the transmission source of the print job, for example. Although the transmission-source address is an internet protocol address (IP address) of the terminal device 200 in a restricted sense, other addresses, such as a MAC address, may be used.

Furthermore, the information for specifying the terminal device 200 is not limited to an address, and other information unique to the device may be used. Since the print job includes information for specifying the terminal device 200 of the transmission source, the print apparatus 100 that executes printing may select the terminal device 200 from which the print job is obtained. Assuming that the second printer 100B determines a print job stored in the first printer 100A as an execution target job, the execution target job may be obtained from the terminal device 200, for example.

Furthermore, the print job stored in the first printer 100A that is one of the other print apparatuses 100 includes user information for specifying a user who has generated the print job. Since the print job includes the user information, authentication printing is enabled and a result of the printing is prevented from unintentionally or mistakenly bringing out. The user information is added when the printer driver 202 generates print data, for example.

Next, the process in step S102 of FIG. 3 will be described in detail with reference to FIGS. 6 and 7. In step S102, obtainment of information required for screen display, a process associated with return, a process of screen display, and the like are performed. FIG. 6 is a diagram schematically illustrating a process of obtaining information on a print job and a process of screen display, and FIG. 7 is a sequence diagram of a flow of the processes.

The user executes a login operation using the second printer 100B serving as the print apparatus 100 to execute printing (step S301). The login operation performed in step S301 is an authentication operation of holding an authentication card over a card reader, for example, as described above.

The second printer 100B performs the process of obtaining information on the first printer 100A and the third to fifth printers 100C to 100E that share a print job with the second printer 100B (step S302). Specifically, the second printer 100B performs a process of inquiring whether a print job of the user who has logged in exists, for example. In a broad meaning, the print apparatus 100 logged in by the user performs the process of obtaining information on the print apparatuses 100 other than itself included in the group sharing the print job (step S302). In the process in step S302, the second printer 100B performs the inquiry using user information indicating the logged-in user as a key.

The individual printers other than the second printer 100B perform a process of returning information (step S303). Specifically, when having a print job of the target user, each of the individual printers returns information on the print job. More specifically, each of the printers obtains the user information from the second printer 100B and returns information on a print job that is determined that user information included in the print job matches the obtained user information. Note that, in the process in step S303, when the individual printers return a print job including print image data, loads of the printers are increased. Therefore, as illustrated in FIG. 6, the second printer 100B obtains data other than at least print image data in the print job in the process in step S303.

Specifically, the second printer 100B obtains identification information of the print job since the print job is required to be uniquely identified. Furthermore, the second printer 100B obtains a transmission source address while it is assumed that the print job is obtained from the terminal device 200 of the transmission source. In this embodiment, the second printer 100B is required to obtain print setting information to determine whether each print job is printable. Furthermore, the user information is used in a user matching process performed in the individual printers other than the second printer 100B, and the second printer 100B may omit obtainment of the user information. Note that the second printer 100B may obtain information on all print jobs from the other printers and perform the matching process of determining whether matching of user information is attained. In this case, the second printer 100B is required to obtain user information from the other printers.

Note that, in the process in step S303, the second printer 100B may obtain metadata indicating a data format of the print image data or a portion of the print image data.

Furthermore, although the operation in step S302 and the operation in step S303 are each performed once in FIG. 7, each of the operations in step S302 and step S303 may be performed a plurality of times. For example, after the obtainment and the return of information indicating whether a print job associated with user information exists are performed, obtainment and return of information indicating whether an existing print job is printable may be performed.

Furthermore, the second printer 100B also obtains information on the print job from the storage section 130 of itself (step S304). This is because the possibility that the print apparatus 100 that receives a print job transmitted from the terminal device 200 matches the print apparatus 100 logged in by the user is considerably large.

After the obtainment of the information on the print job, the second printer 100B displays various screens based on the obtained information in the display section 150 (step S305). Examples of the various screens include a home screen display 300 described below with reference to FIG. 10, a print designation disabling display 400 associated with the home screen display 300, and a guide designation 410.

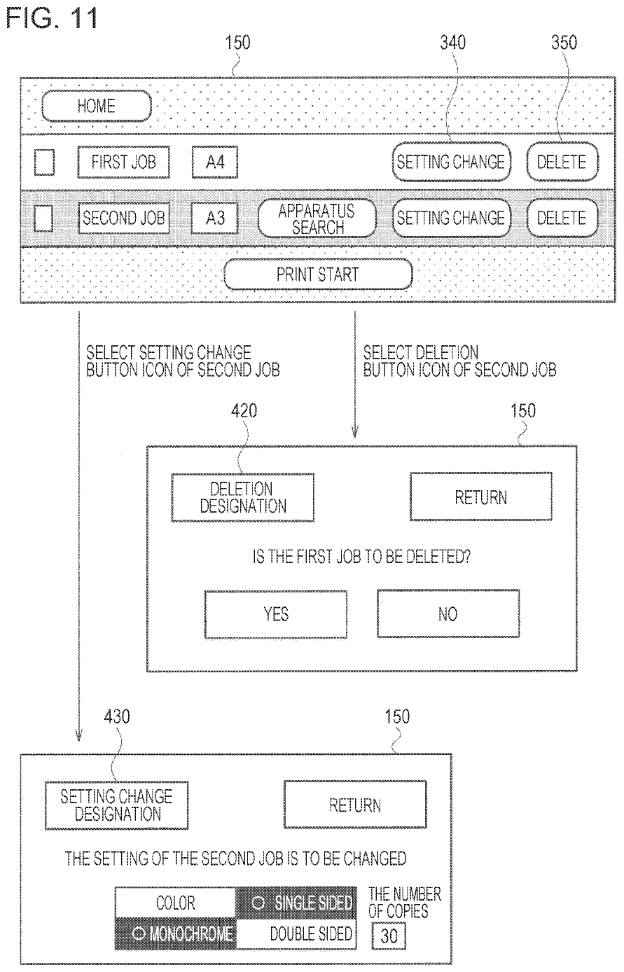

Note that the user may modify the information on a print job in this embodiment. In this case, the second printer 100B performs an information change process on the other print apparatuses 100 (step S310) and performs screen display on the display section 150 based on the changed information (step S312). The detail thereof will be described hereinafter with reference to FIG. 11.

Furthermore, the processing section 110 may periodically determine whether communication with the other print apparatuses 100 through the communication section 120 is available. Then the processing section 110 performs a process of excluding some of the other print apparatuses 100 that are determined that the communication is not available from targets of obtainment of information on the print job. In this way, a request for the information on the print job to the print apparatuses 100 that are not available for communication may be avoided. When a request for obtaining information on the print job is issued to the print apparatuses 100 that are not available for communication, for example, the user has to wait until a time-out is detected, and therefore, a long period of time is required from when the user logged in in step S301 to when the screen display is performed in step S305 and the user may become stressful. However, a target of the process in step S302 is limited to the print apparatuses 100 that are available for communication by checking states of the individual print apparatuses 100 in advance in the background, and therefore, a period of time from the login to the display of a job selection screen may be reduced.

FIG. 8 is a sequence diagram of a flow of the print process performed in step S103. First, the processing section 110 of the second printer 100B receives a selection input performed by the user on the job selection screen. Thereafter, the processing section 110 determines a selected print job as an execution target job (step S401). By this, the execution target job may be appropriately determined using the job selection screen.

The second printer 100B transmits a request for obtaining the execution target job to the first printer 100A (step S405), and the first printer 100A returns the execution target job (step S406). Specifically, the second printer 100B specifies identification information of the execution target job determined based on the job selection screen and transmits the obtainment request including the identification information to the processing section 110 of the first printer 100A. The processing section 110 of the first printer 100A obtains print setting information and print image data associated with the obtained identification information from the storage section 130 of itself. Then the processing section 110 of the first printer 100A transmits the obtained print setting information and the obtained print image data to the second printer 100B.

Subsequently, the second printer 100B performs printing using the print section 140 based on the obtained print setting information and the obtained print image data so as to supply a printed matter that is a result of the printing to the user (step S407).

Thereafter, the processing section 110 of the second printer 100B transmits a deletion request to the first printer 100A that is one of the other print apparatuses 100 and the terminal device 200 (step S408 and step S409). The deletion request issued in step S408 and step S409 is transmitted after being associated with the identification information of the execution target job. Specifically, the terminal device 200 deletes the various information associated with the specified identification information from the job pool 203. Furthermore, the first printer 100A deletes the various information associated with the specified identification information from the storage section 130 of itself. Accordingly, when the print process of the given print job is completed, various apparatuses that store the information associated with the print job may appropriately execute the deletion process.

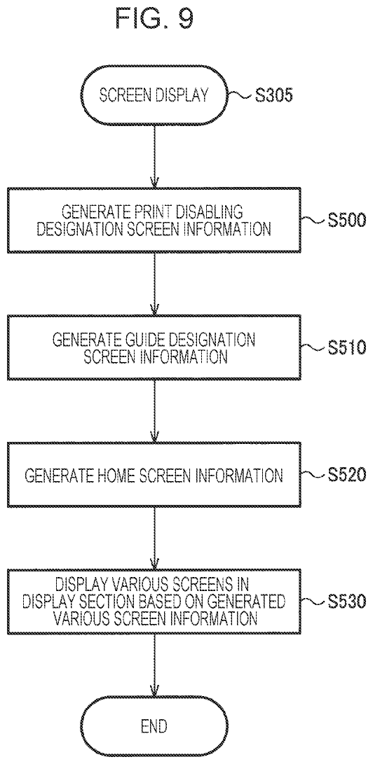

FIG. 9 is a flowchart of the screen display (step S305) illustrated in detail. The display controller 114 of the second printer 100B performs a process of generating print disabling designation screen information (step S500). Specifically, the display controller 114 determines whether printing of individual print jobs may be performed by itself, that is, whether a desired printing result is obtained by the second printer 100B based on the information received in step S303, and performs a process of generating screen information indicating a print job that is determined not to obtain a desired printing result by itself. A concrete example of the screen will be described hereinafter with reference to FIG. 10.

The display controller 114 of the second printer 100B performs a process of generating guide designation screen information (step S510). Specifically, in step S303 described above, the display controller 114 performs a process of generating screen information for guide to some of the print apparatuses 100 capable of obtaining a desired printing result for the print job that is determined not to be printed by itself, that is, by the second printer 100B itself, based on information return for the determination as to whether printing is available for individual print jobs supplied from the other print apparatuses 100. A concrete example of the screen will be described hereinafter with reference to FIG. 10 and the like.

Subsequently, the display controller 114 of the second printer 100B performs a process of generating home screen information (step S520). Specifically, the display controller 114 performs a process of generating screen information of the home screen display 300 as illustrated in FIG. 10 based on the various screen information generated in step S510 and step S520. For example, the display controller 114 of the second printer 100B performs a process of displaying an icon of the print job on a certain background image in an overlapping manner, a process of displaying an apparatus search button icon 320, which is described hereinafter, where appropriate in an overlapping manner, and the like.

Thereafter, the display controller 114 of the second printer 100B performs a process of displaying various screens on the display section 150 based on the generated various screen information (step S530). Specifically, the display controller 114 displays the home screen display 300 described below, and thereafter, appropriately performs a process of displaying the print designation disabling display 400 and the guide designation 410 when the user selects various icons described below.

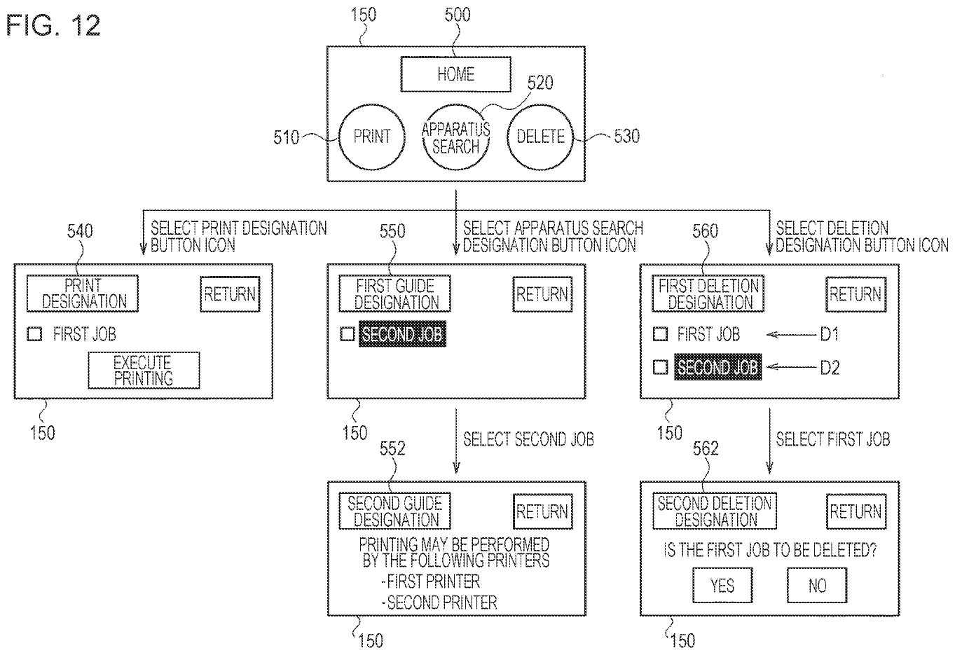

FIG. 10 is a diagram illustrating an example of a screen employing the method according to this embodiment. Note that, it is assumed, in a description below, that the user in front of the third printer 100C views an example of display on the display section 150 when a print job only corresponding to A3 paper is transmitted to the first printer 100A. Specifically, it is assumed that the third printer 100C only corresponding to A4 paper may not print a print job only corresponding to A3 paper. The same is true of the fourth and fifth printers 100D and 100E. Similarly, it is assumed, in screen examples illustrated in FIGS. 11 and 12 described below, that a user in front of the third printer 100C views an example of display on the display section 150. These screen examples are realized by the process performed in step S305 in FIG. 7 described above.

After the user performs authentication using the third printer 100C, the home screen display illustrated in FIG. 10 is displayed in the display section 150. In the example of the home screen display 300, an icon indicating a first job corresponding to A4 paper and an icon indicating a second job corresponding to A3 paper are individually displayed. Furthermore, checkbox icons 310 are displayed on the icons of the print jobs in an overlapping manner so that a print job selected by the user is recognized. Furthermore, the user selects the checkbox icon 310 of the first job that is printable by the third printer 100C and further selects a print start button icon 330, so that the first job is printed. Furthermore, in the example of FIG. 10, background of the home screen display 300 is displayed by colors indicated by B1 and B4.

As described above, the third printer 100C may not print a print job corresponding to A3 paper. Therefore, when the user selects the checkbox icon 310 corresponding to the second job, the print designation disabling display 400 is displayed. By this, the user may recognize whether the selected print job may be printed by the third printer 100C. Note that, although the home screen display 300 is switched to the print designation disabling display 400 in the example of FIG. 10, the display is not limited to this and the print designation disabling display 400 of a reduced size may be displayed on the home screen display 300 in an overlapping manner. The same is true of the guide designation 410, a deletion designation 420 and a setting change designation 430 that are described below with reference to FIG. 11, and a print designation 540, a first guide designation 550, a second guide designation 552, a first deletion designation 560, and a second deletion designation 562 that are described below with reference to FIG. 12.

Furthermore, when the user selects the apparatus search button icon 320 displayed on the icon of the second job in an overlapping manner, the guide designation 410 is displayed. That is, the display controller 114 of the third printer 100C performs display control for guiding the second job to the other print apparatuses 100 capable of printing the second job. Specifically, the display controller 114 of the third printer 100C performs display control for a guide indicating that the first and second printers 100A and 100B corresponding to A3 paper are available for printing. By this, the user may recognize the print apparatuses 100 capable of printing the print job that may not be printed by the print apparatus 100 installed in front of the user.

Note that, when the user selects the checkbox icon 310 of the second job, a process of changing a display state of the print start button icon 330 to a predetermined state and a process of not accepting a selection performed by the user may be appropriately added to the process described above. Although the predetermined state is a translucent state, for example, the print start button icon 330 may not be displayed or any state may be employed as long as the state indicates an unprintable state. By this, the user may easily recognize that the second job may not be printed by the third printer 100C.

Furthermore, the apparatus search button icon 320 is displayed only on an icon of an unprintable job in an overlapping manner. Specifically, as indicated by C, the apparatus search button icon 320 is not displayed on the icon of the first job that is a printable job in an overlapping manner. Accordingly, the user may easily recognize whether individual print jobs are printable based on whether the apparatus search button icon 320 is displayed.

Furthermore, as indicated by B2 and B3, the icon of the first job that is printable and the icon of the second job that is unprintable may be different in color. Furthermore, the colors of the first and second jobs may be differentiated from the background colors of the home screen display 300 indicated by B1 and B4. In this way, a printable job and an unprintable job may be easily distinguished from each other in the display section 150.

As described above, the print apparatus 100 of this embodiment is connectable to the other print apparatuses 100 through the network, and include the obtaining section 112 that obtains information on print jobs included in the other print apparatuses 100 and the display controller 114 that displays, among the print jobs included in the other print apparatuses, a first job that is printable by itself and a second job that is not printable by itself as a list in a distinguishable manner. The display controller 114 performs display control that enables a print designation to be performed by the user on the first job and display control that disables a print designation to be performed by the user on the second job, and in addition, performs display control on the guide designation for guiding the second job to the other print apparatuses 100 capable of printing the second job. In this way, since the first job printable by itself and the second job that is not printable by itself are displayed in a distinguishable manner, the user may easily recognize existence of the second job. Furthermore, since the guide designation 410 is displayed, the user may recognize the print apparatus 100 capable of printing the second job. In general, a print apparatus 100 performs only display indicating that an unprintable second print job may not be printed, and therefore, a user is confused since the user does not recognize a print apparatus 100 to be used for printing and operations do not smoothly proceed, which is a problem. However, when the method of this embodiment is employed, a user using a print apparatus 100 may perform an operation of searching for another print apparatus 100 capable of printing a print job that is unprintable by the print apparatus 100 being used by the user. Accordingly, the user may quickly recognize the print apparatus 100 capable of printing the print job and operations may smoothly proceed.

Note that the method of this embodiment is not limited to this, and various modifications may be made including an addition of another component. The items settable by the user are not limited to those described above. Furthermore, the same is true of a job that is printable by some print apparatuses and that is not printable by the other print apparatuses due to another capability of print apparatuses. FIG. 11 is a diagram illustrating another display example employing the method according to this embodiment. Note that reference numerals of the components that have been described with reference to FIG. 10 are omitted in FIG. 11. The home screen display 300 may further include, as illustrated in FIG. 11, a setting change button icon 340 and a deletion button icon 350 in addition to the various icons described above. When the user selects the deletion button icon 350 displayed on the icon of the first job or the second job in an overlapping manner, a screen of the deletion designation 420 is opened and confirmation of deletion of a print job associated with the icon overlapping with the deletion button icon 350 is displayed. For example, although not illustrated, the display of the deletion designation 420 is realized by adding a process of generating screen information on the deletion designation 420 to the process in step S305 of FIG. 9.

When the user performs an operation of deleting the second job, for example, the icon of the second job is deleted. For example, the processing section 110 of the third printer 100C transmits a command for deleting information on the second job to the first printer 100A having print image data of the second job in step S310 as described above. Then the processing section 110 of the first printer 100A deletes the information on the second job stored in the storage section 130. Furthermore, the display controller 114 of the third printer 100C performs display control of a screen in which the change is reflected in step S312. Specifically, the display controller 114 of the third printer 100C performs display control such that the icon of the second job is deleted from the display section 150. By these processes, the display control associated with the deletion is realized.

Note that, unlike the apparatus search button icon 320 described above, the deletion button icon 350 is displayed on the icons of all the print jobs in an overlapping manner. This is because, irrespective of a printable print job or an unprintable print job, the user may mistakenly transmit print job data to the print apparatuses 100.

As described above, the display controller 114 of this embodiment performs display control of the deletion designation 420 for enabling deletion performed by the user on the first and second jobs. When unrequired data, such as a print job mistakenly transmitted, is repeatedly stored in the storage section 130, there arises a problem in that a new print job may not be stored. However, when the method of this embodiment is employed, unrequired print jobs may be appropriately deleted from the print apparatus 100, and therefore, a storage region of the storage section 130 may be ensured. Accordingly, the problem in which a new print job may not be stored may be avoided, and degradation of usability of the print system 10 may be suppressed.

Furthermore, when the user selects the setting change button icon 340 displayed on the icon of the first job icon or the second job in an overlapping manner, the setting change designation 430 is displayed. Then, in the setting change designation 430, the user may change settings of the print job associated with the icon overlapping with the setting change button icon 340. For example, as is the case of the deletion designation 420, the display of the setting change designation 430 is realized by adding a process of generating screen information of the setting change designation 430 to the process in step S305 of FIG. 9.

Although items of the setting change include a setting for selecting color printing or monochrome printing, a setting for selecting single-sided printing or a double-sided printing, and a setting for changing the number of copies as illustrated in FIG. 11, for example, the items are not limited to these and other items of the setting change may be displayed. When the user performs an operation associated with a setting change of a certain print job, the processing section 110 of the third printer 100C issues an instruction for changing print setting information to the print apparatuses 100 having print setting information of the certain print job in step S310. Then the processing section 110 of the print apparatuses 100 that have received the instruction performs a process of changing the print setting information stored in the storage section 130. Note that, when the information on the certain print job is stored in the storage section 130 of the third printer 100C, the processing section 110 of the third printer 100C does not perform the process in step S310 but performs a process of changing print setting information stored in the storage section 130 of itself. Furthermore, the display controller 114 of the third printer 100C performs display control of a screen in which a setting after the change is reflected in step S312. Specifically, the display controller 114 of the third printer 100C performs display control such that the setting change designation 430 is updated.

Furthermore, the display controller 114 of the third printer 100C may perform display control such that a certain item of the setting change is not displayed. For example, when none of the print apparatuses 100 included in the print system 10 is capable of performing double-sided printing, display control for not displaying a setting for selecting single-sides printing or double-sided printing may be performed. Note that, although not illustrated in FIG. 7, when the setting change is performed in step S310, the various print apparatuses 100 instructed in step S310 may additionally perform a process of returning information to the print apparatus 100 that has issued the instruction. For example, when a print job that is unprintable before the setting change becomes printable by the setting change, the print apparatuses 100 that received the instruction of the setting change in step S310 may return information indicating that the print job has become printable to the print apparatus 100 that has issued the instruction of the setting change. Furthermore, in this case, the display controller 114 of the print apparatus 100 that has issued the instruction for setting change may perform display control on a screen corresponding to the setting change in step S312. For example, the display controller 114 of the print apparatus 100 that has issued the instruction for setting change performs display control including a change in color of an icon of a print job that becomes printable by the setting change and deletion of the apparatus search button icon 320 displayed in an overlapping manner.

As described above, the display controller 114 of this embodiment performs display control of the setting change designation 430 for enabling a setting change of print jobs included in the other print apparatuses 100. For example, the user may not recognize a mistake of a setting of a print job until the user arrives at a location where a print apparatus 100 of print execution is installed. Furthermore, when the print job including the inappropriate setting is a second job that is not printable by the print apparatus 100, the user asks another person who uses a print apparatus 100 installed in another location to perform change in a setting of the second job and printing of the second job that has been subjected to the setting change, and therefore, loads of a request source and a request destination are increased. Therefore, troubles including inappropriate transmission are likely to occur, and it is highly likely that a problem in which a desired printed matter may not be obtained arises. However, when the method of this embodiment is employed, the request source may change a setting of the second job by itself and only requests the request destination to print the second job, and therefore, the loads of the request source and the request destination may be reduced. Accordingly, since the request destination may smoothly execute printing and the request source may obtain a desired printed matter, usability of the print system 10 may be improved.

Furthermore, the screen example employing the method of this embodiment is not limited to that described above. Although the printable first job and the unprintable second job are simultaneously displayed in the home screen display 300 in the examples illustrated in FIGS. 10 and 11, for example, the display is not limited to this. A screen for displaying only the first job, a screen for displaying only the second job, and a screen for displaying both the first and second jobs may be separately displayed depending on a purpose, for example. Note that a display example described below may be realized by appropriately employing the method described above, and therefore, a detailed description thereof is omitted.

FIG. 12 is a diagram illustrating a modification of this embodiment. When the print apparatus 100 is activated, home screen display 500 is displayed in the display section 150. The home screen display 500 includes a print designation button icon 510, an apparatus search designation button icon 520, and a deletion designation button icon 530.

When the user selects the print designation button icon 510, a print designation 540 is displayed. In this case, the print designation 540 displays a list of icons associated with printable print jobs. The user may obtains a desired printed matter by selecting an icon of the first job that is a print job desired to print and further selecting an icon of print execution.

Furthermore, when the user selects the apparatus search button icon 520, a first guide designation 550 is displayed. In this case, the first guide designation 550 displays a list of icons associated with printable print jobs. Thereafter, when the user selects the icon of the second job that is unprintable by the third printer 100C but desired to be printed using the other print apparatuses 100, a second guide designation 552 is displayed. In the second guide designation 552, print apparatuses 100 that are capable of printing the second job are listed.

Furthermore, when the user selects the deletion designation button icon 530, a first deletion designation 560 is displayed In this case, in the first deletion designation 560, an icon of the printable first job and an icon of the unprintable second job are simultaneously displayed as a list. Furthermore, as indicated by D1 and D2, a state of the icon of the first job and a state of the icon of the second job are different from each other in the display. By this, the user may easily recognize whether the print job is printable by the third printer 100C. Then the user may select a print job to be deleted. For example, when the user selects the icon of the first job, a second deletion designation 562 is displayed in the second deletion designation 562, the user is requested to determine whether the first job is to be deleted.

As described above, the print apparatus 100 of this embodiment is connectable to the other print apparatuses 100 through the network, and includes the obtaining section 112 that obtains information on print jobs included in the other print apparatuses 100 and the display controller 114 that displays a list of a first job printable by itself and a second job not printable by itself in the print jobs included in the other print apparatuses such that one of the first jobs and the second jobs is selectable. The display controller 114 performs display control for displaying the first deletion designation 560 that is a deletion screen used to designate deletion of a print job included in the other print apparatuses 100 separately from the first screen, and display control such that the first job and the second job are distinguishable and selectable in the first deletion designation 560 that is a deletion screen. In the display examples of FIGS. 10 and 11, the printable first job, the unprintable second job, and the print start button icon 330 are simultaneously displayed in the home screen display 300. On the other hand, in the display example of FIG. 12, only the printable first job is displayed in the print designation 540 whereas the printable first job and the unprintable second job are simultaneously displayed in the first deletion designation 560. In this way, since only a job of a target of printing, apparatus search, or deletion is displayed, a print job suitable for a purpose may be appropriately displayed. Note that, although not illustrated, another screen associated with setting change may be separately provided and may be called by a setting change button.

As described above, a print apparatus of this embodiment is connectable to other print apparatuses through a network, and include an obtaining section that obtains information on print jobs of the other print apparatuses and a display controller that displays, among the print jobs of the other print apparatuses, a first job that is printable by itself and a second job that is not printable by itself as a list in a distinguishable manner. The display controller performs display control that enables a print designation to be performed by the user on the first job and display control that disables a print designation to be performed by the user on the second job, and in addition, performs display control of the guide designation for guide to the other print apparatuses capable of printing the second job.

In this way, since the first job that is printable by itself and the second job that is not printable by itself may be displayed in a distinguishable manner, the user may easily recognize existence of the second job. Furthermore, since the user may perform an operation of searching for another print apparatus that is capable of printing a print job not printable by itself, the user may quickly recognize a print apparatus capable of printing the print job and usability of a print system may be improved.

Furthermore, the display controller may perform display control of deletion designation for enabling deletion performed by the user on the first and second jobs.

By this, the problem in which a new print job may not be stored may be avoided, and degradation of usability of the print system may be suppressed.

Furthermore, the display controller may perform display control of setting change designation for enabling a setting change of print jobs included in the other print apparatuses.

By this, when a request for printing, using another print apparatus, an unprintable job in which a setting is to be changed is issued, loads of a request source and a request destination may be reduced and usability of the print system may be improved.

Furthermore, the print apparatus of this embodiment is connectable to the other print apparatuses through the network, and include the obtaining section that obtains information on print jobs included in the other print apparatuses and the display controller that displays a list of a first job printable by itself and a second job not printable by itself in the print jobs included in the other print apparatuses in a distinguishable manner. The display controller performs display control of a deletion screen for designating deletion of a print job included in another print apparatus and performs display control such that the first job and the second job are distinguishable and selectable.

In this way, when a print job printable by itself and a print job unprintable by itself are mixed, an appropriate print job suitable for a purpose may be displayed.

Note that, although this embodiment is described in detail as described above, those skilled in the art may easily understand that various modifications may be made without substantially departing from novelty and effects of the present disclosure. Accordingly, these modifications are included in the scope of the present disclosure. For example, a term described with a different term that has wider meaning or the same meaning at least once in the specification and the drawings may be replaced by the different term in any portion in the specification and the drawings. Furthermore, all combinations of the embodiment and the modifications are included in the scope of the present disclosure. Furthermore, the configurations and the operations of the print apparatuses are not limited to those described in this embodiment and various modifications may be made.

What is claimed is:

1. A print apparatus connectable to another print apparatus through a network, the print apparatus comprising:
an obtaining section that obtains information on a print job of the other print apparatus; and
a display controller that displays, among print jobs of the other print apparatus, a first job that is printable by itself and a second job that is not printable by itself as a list in a distinguishable manner,
wherein the display controller
performs display control for enabling a print designation to be performed by a user on the first job,
performs display control for disabling the print designation to be performed by the user on the second job, and
performs display control of a guide designation for guiding the second job to the other print apparatus configured to print the second job.

2. The print apparatus according to claim 1, wherein the display controller performs display control for a deletion designation that enables deletion performed by the user on the first job and the second job.

3. The print apparatus according to claim 1, wherein the display controller performs display control for a setting change designation that enables a change in a print setting on the first job and the second job.

4. A print apparatus connectable to another print apparatus through a network, the print apparatus comprising:
an obtaining section that obtains information on a print job of the other print apparatus; and
a display controller that displays in a first screen, among print jobs of the other print apparatus, a first job that is printable by itself and a second job that is not printable by itself as a list such that only one of the first and second jobs is selectable,
wherein the display controller
performs display control for displaying a deletion screen for enabling a designation of deletion of a print job included in the other print apparatus separately from the first screen, and
performs display control such that the first job and the second job are distinguishable and selectable in the deletion screen.
